(19) United States
(12) Patent Application Publication
(10) Pub. No.: US 2007/0070950 A1
(43) Pub. Date: Mar. 29, 2007

(54) Apparatus and method for selecting two neighboring cells in cellular environments

(75) Inventors: Ki-Young Han, Yongin-si (KR); Young-Hoon Kwon, Seongnam-si (KR); Soon-Young Yoon, Seoul (KR); Sung-Soo Hwang, Suwon-si (KR)

Correspondence Address: DILWORTH & BARRESE, LLP, 333 EARLE OVINGTON BLVD., SUITE 702, UNIONDALE, NY, 11553, US

(73) Assignee: Samsung Electronics Co., Ltd., Gyeonggi-do (KR)

(21) Appl. No.: 11/526,999

(22) Filed: Sep. 26, 2006

(30) Foreign Application Priority Data
Sep. 28, 2005 (KR) 2005-0090725

(51) Int. Cl. H04Q 7/00

(52) U.S. Cl. 370/332

(57) ABSTRACT

Apparatus and method for simultaneously selecting two cells in a broadband cellular communication system with a frequency reuse factor of N. Adjacent cells are searched and the RX power strengths of the adjacent cells are measured. Cells with RX power strengths greater than a predetermined value are selected among the adjacent cells. Two cells are selected among the selected cells and the FAs and RX power strengths of the two cells are compared. If the two cells have adjacent FAs and/or similar RX power strengths, the two cell are selected to perform communication. The apparatus and method simultaneously receives data signals from two cells with adjacent FAs in a cellular environment with a frequency reuse factor of N, by sharing the adjacent FAs.

### PRIORITY

This application claims priority under 35 U.S.C. § 119 to an application entitled “Apparatus and Method for Selecting Two Neighboring Cells in Cellular Environments” filed in the Korean Intellectual Property Office on Sep. 28, 2005 and assigned Serial No. 2005-90725, the contents of which are incorporated herein by reference.

### BACKGROUND OF THE INVENTION

1. Field of the Invention

The present invention relates generally to an apparatus and method for simultaneously receiving data signals from two cells that have adjacent frequency allocations (FAs) in a cellular environment, and in particular, to an apparatus and method for enabling a mobile station (MS) to simultaneously receive data signals from two cells that have adjacent FAs and similar receive (RX) power in a cellular environment with a frequency reuse factor of N.

2. Description of the Related Art

Cellular systems have been proposed to alleviate service area and subscriber capacity restrictions. In conventional cellular systems, the service area is divided into a plurality of sub-areas (i.e., cells). Two cells spaced apart from each other by a sufficient distance use the same FA so that frequency resources can be spatially reused. Accordingly, conventional cellular systems can increase the number of spatially-distributed channels, thereby making it possible to accommodate a sufficient number of subscribers.

FIG. 1 is a schematic diagram illustrating a conventional cellular system of a Global System for Mobile communications/General Packet Radio Service (GSM/GPRS) network.

As illustrated in FIG. 1, a service area of the GSM/GPRS network is divided into a plurality cells that have a frequency reuse factor of more than 1. That is, the GSM/GPRS network reuses frequency bands of nonadjacent cells and allocates different channel frequency resources to the cells according to traffic loads.

In the conventional cellular system, an MS selects a cell for performing the most stable communication service possible.

FIG. 2 is a flowchart illustrating a conventional procedure for selecting a cell in the conventional cellular system. In the following description, a GSM system is taken as an example of the conventional cellular system.

Referring to FIG. 2, in step 201, the MS is booted to scan and identify if it receives Broadcast Control Channels (BCCHs) of a plurality cells. If so, the MS proceeds to step 203; and if not, the MS repeats step 201.

In step 203, the MS measures the RX power strengths of the received BCCHs, selects a predetermined number of the BCCHs whose RX power strengths are higher than a predetermined level, and arranges the selected BCCHs in the descending order of strengths of the RX powers.

In step 205, the MS demodulates a Frequency Correction Channel (FCCH) of one of the arranged BCCHs whose RX power is strongest.

In step 207, the MS demodulates a Synchronization Channel (SCH) of the BCCHs. Using the FCCH and the SCH, the MS acquires synchronization with the BCCH of a cell having the strongest RX power.

In step 209, the MS selects the cell with the strongest RX power to perform communication. Thereafter, the MS ends the procedure.

As described above, the MS of the conventional cellular system selects one of cells based on the strengths of the RX powers of the cells. However, even when two cells have similar RX strengths, the MS must select one of the two cells because it cannot simultaneously receive data signals from two cells.

### SUMMARY OF THE INVENTION

An object of the present invention is to substantially solve at least the above problems and/or disadvantages and to provide at least the advantages below. Accordingly, an object of the present invention is to provide an apparatus and method for simultaneously receiving data signals from cells that have adjacent FAs in a cellular environment.

Another object of the present invention is to provide an apparatus and method for enabling an MS to simultaneously receive data signals from cells that have adjacent FAs and similar RX power in a cellular environment.

A further object of the present invention is to provide an apparatus and method for simultaneously receiving data signals from BSs that have adjacent FAs in a cellular environment, thereby achieving a diversity gain.

According to an aspect of the present invention, there is provided a mobile station apparatus for simultaneously receiving two adjacent FAs in a broadband cellular communication system with a frequency reuse factor of N, the mobile station apparatus including a cell selector for detecting the RX power strengths and FAs of adjacent cells to select a cell for performing communication; a frequency controller for selecting, if the cell selector selects two cells with adjacent FAs, a carrier for simultaneously receiving the adjacent FAs of the two cells; a local oscillator for generating the selected carrier; and a multiplier for multiplying the generated carrier by a received signal to generate a baseband signal.

According to another aspect of the present invention, there is provided a method for simultaneously selecting two cells in a broadband cellular communication system with a frequency reuse factor of N, the method including searching adjacent cells and measuring the strengths of the RX powers of the adjacent cells; selecting only cells with RX power strengths greater than a predetermined value among the adjacent cells; selecting two cells among the selected cells and comparing the FAs and RX power strengths of the two cells; and if the two cells have adjacent FAs and similar RX power strengths, selecting the two cells to perform communication.

### BRIEF DESCRIPTION OF THE DRAWINGS

The above and other objects, features, and advantages of the present invention will become more apparent from the following detailed description when taken in conjunction with the accompanying drawings in which:

FIG. 1 is a schematic diagram illustrating a conventional cellular system of a GSM/GPRS (Global System for Mobile Communication/General Packet Radio Service) network;

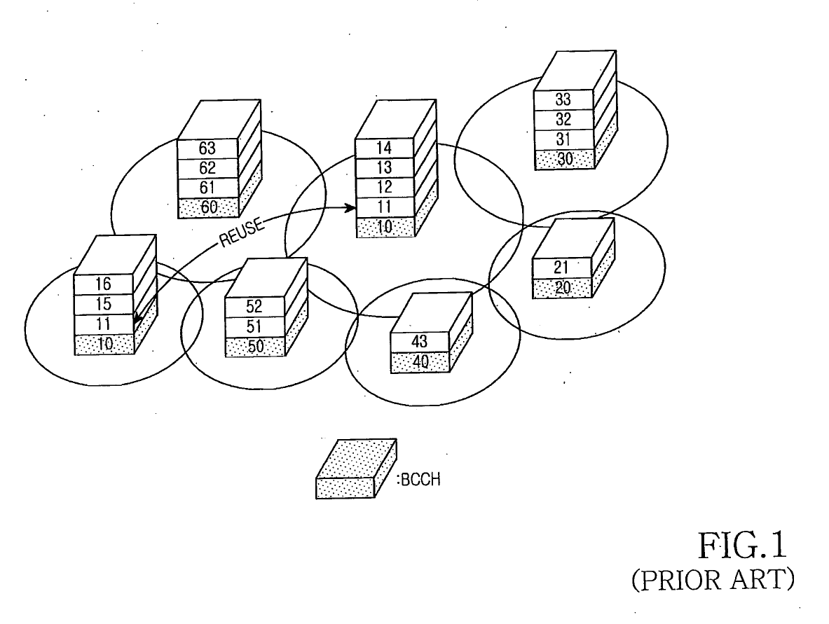

FIG. 2 is a flowchart illustrating a conventional procedure for selecting a cell in the conventional cellular system;

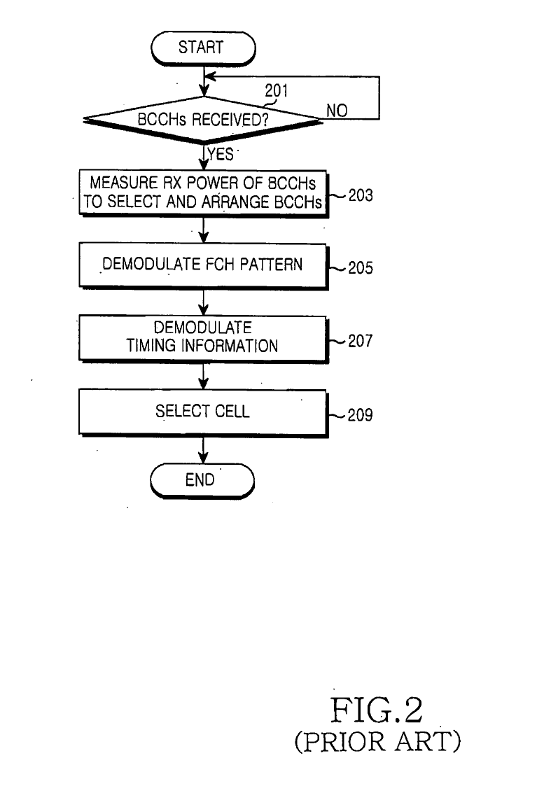

FIG. 3 is a schematic diagram illustrating a structure of a mobile communication system for simultaneously receiving data signals from two BSs with adjacent FAs, according to the present invention;

FIG. 4 is a block diagram of a BS that enables an MS to simultaneously receive two adjacent FAs, according to the present invention;

FIG. 5 is a block diagram of an MS for supporting band sliding according to the present invention;

FIG. 6 is a flowchart illustrating a procedure for selecting cells according to the present invention; and

FIG. 7 is a flowchart illustrating a procedure for simultaneously selecting two BSs according to the present invention.

### DETAILED DESCRIPTION OF THE PREFERRED EMBODIMENTS

Preferred embodiments of the present invention will be described herein below with reference to the accompanying drawings. In the following description, well-known functions or constructions are not described in detail because they would obscure the present invention in unnecessary detail.

The present invention provides an apparatus and method for enabling an MS to select two cells that have adjacent FAs and similar RX power in a cellular environment and to simultaneously receive data signals from the two cells.

In the following description, the bandwidth that an MS transmitting a maximum amount of information occupies in the cellular environment is referred to as “FA bandwidth”. Also, the MS and the BSs will be assumed to have the same bandwidth. In addition, band sliding means a scheme in which an MS slides its in-use FA between two adjacent FAs of two neighboring cells to simultaneously receive data signals from the two neighboring cells.

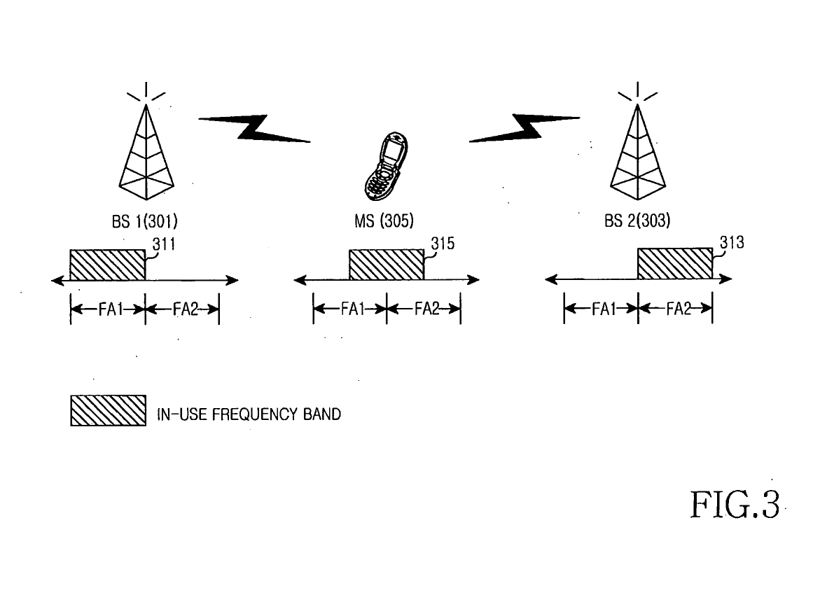

FIG. 3 is a schematic diagram illustrating a structure of a mobile communication system for simultaneously receiving data signals from two cells with adjacent FAs, according to the present invention. In the following description, it is assumed that each cell has a single BS.

Referring to FIG. 3, first and second BSs 301 and 303 adjacent to each other use a first FA 311 and a second FA 313, respectively. The first and second FAs 311 and 313 are adjacent to each other. An MS 305 simultaneously receives data signals from the first and second BSs 301 and 303 by shifting its FA 315 such that the FA 315 includes both a portion of the first FA 311 and a portion of the second FA 313.

In order for the MS 305 to successfully communicate with the two BSs 301 and 303, data frame structures transmitted from the two BSs 301 and 303 must support a structure for demodulating data by receiving only the portions of the two FAs. That is, even when the MS 305 receives only the portions of the two FAs, a frame structure capable of including the control information and the preamble of the frame should be supported.

Although not illustrated, in order for the MS 305 to receive data by using only the portions of the two FAs of the BSs 301 and 303, control information can be located at a subcarrier in a predetermined section where the two FAs are adjacent to each other. That is, because the MS 305 receives data by using the neighboring portions of the two FAs of the BSs 301 and 303, the BSs 301 and 303 include the control information and the minimum bandwidth of a preamble for discriminating the BS at the portion of the FA received by the MS 305. At this point, in order to distinguish the BSs, the preamble is repeatedly mapped throughout the entire in-use FA of the BS to construct a frame.

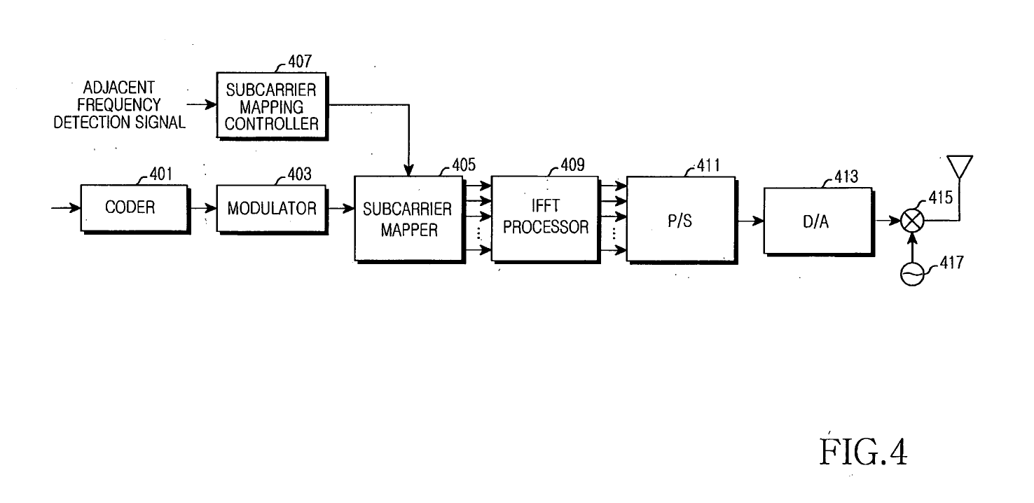

FIG. 4 is a block diagram of a BS that enables an MS to simultaneously receive two adjacent FAs, according to the present invention.

Referring to FIG. 4, the BS includes a coder 401, a modulator 403, a subcarrier mapper 405, a subcarrier mapping controller 407, an inverse fast Fourier transform (IFFT) processor 409, a parallel-to-serial (P/S) converter 411, a digital-to-analog (D/A) converter 413, a multiplier 415, and a local oscillator 417.

The coder 401 channel-codes input information data at a predetermined coding rate to output the resulting data to the modulator 403. The modulator 403 modulates the data from the coder 401 by a predetermined modulation scheme to output the resulting data to the subcarrier mapper 405. Examples of the predetermined modulation scheme include a Binary Phase Shift Keying (BPSK) modulation scheme, a Quadrature Phase Shift Keying (QPSK) modulation scheme, a 16-QAM (Quadrature Amplitude Modulation) scheme, and a 64-QAM scheme.

Under the control of the subcarrier mapping controller 407, the subcarrier mapper 405 maps the data from the modulator 403 to subcarriers to output the resulting data (i.e., frequency-domain data) to the IFFT processor 409. When there is an another BS using an FA adjacent to the FA of the BS, the subcarrier mapping controller 407 generates a control signal for mapping control information of a TX signal (e.g., a preamble signal and FA allocation information) to a predetermined subcarrier where the two FAs are adjacent to each other, so that the MS can simultaneously receive data signals from the two BSs.

The IFFT processor 409 IFFT-processes the frequency-domain data from the subcarrier mapper 405 to output time-sampled data (i.e., parallel data) to the P/S converter 411. The P/S converter 411 converts the parallel data from the IFFT processor 409 into serial data to output the resulting data (i.e., a digital signal) to the D/A converter 413. The D/A converter 413 converts the digital signal from the P/S converter 411 into an analog signal to output an analog baseband signal to the multiplier 415. The multiplier 415 multiplies the analog baseband signal from the D/A converter 413 by an oscillating signal from the local oscillator 417 to generate a radio-frequency (RF) signal. The RF signal is transmitted through an antenna (ANT).

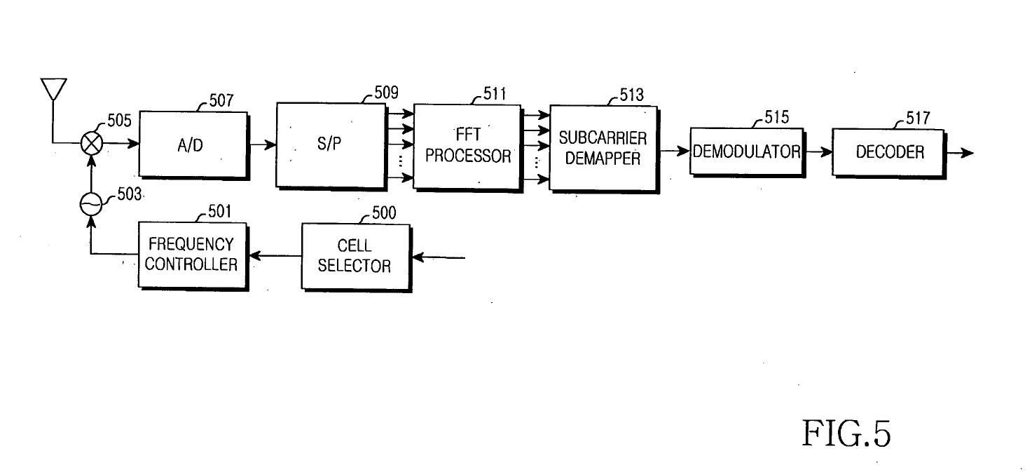

FIG. 5 is a block diagram of an MS for supporting band sliding according to the present invention.

Referring to FIG. 5, the MS includes a cell selector 500, a frequency controller 501, a local oscillator 503, a multiplier 505, an analog-to-digital (A/D) converter 507, a serial-to-parallel (S/P) converter 509, a fast Fourier transform (FFT) processor 511, a subcarrier demapper 513, a demodulator 515, and a decoder 517.

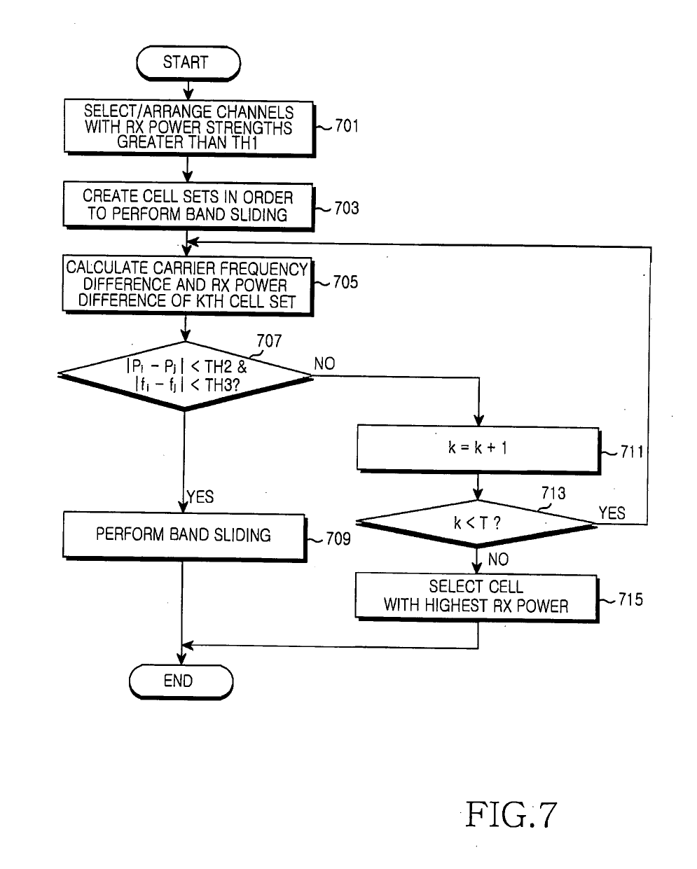

The cell selector 500 measures the power of a signal (e.g., a BCCH signal) received from each cell, selects a cell for performing communication, and provides information about the selected cell to the frequency controller 501. According to the present invention, if two cells among cells with RX power strengths higher than a predetermined level have adjacent FAs and an RX power difference of the two cells is smaller than a predetermined threshold, the cell selector 500 selects both of the two cells. This will be described in detail with reference to FIG. 7.

The frequency controller 501 generates a control signal for selecting an FA to be used by the MS. That is, because the MS uses a predetermined bandwidth, the frequency controller 501 generates a control signal for selecting a carrier that is a center frequency of the MS. In addition, when the cell selector 500 simultaneously selects two cells with adjacent FAs, the frequency controller 501 generates a control signal for selecting the FA 315 (e.g., see FIG. 3) for simultaneously receiving data signals from the two selected cells (BSs). That is, the frequency controller 501 generates a control signal for selecting a center frequency (i.e., a carrier) for simultaneously receiving data signals from the two selected cells.

The local oscillator 503 generates the carrier (i.e., the center frequency of the BS) under the control of the frequency controller 501. At this point, the carrier is selected such that it includes a preamble of the minimum bandwidth for distinguishing between the BSs and control information of each of the two neighboring FAs.

The multiplier 505 multiplies a signal received through an antenna by a carrier received from the local oscillator 503, thereby creating an FA for simultaneously receiving signals from the two base stations. The A/D converter 507 converts an output signal from the multiplier 505 into a digital signal. The digital signal includes time-sampled data (i.e., serial data).

The S/P converter 509 coverts the serial data from the A/D converter 507 into parallel data. The FFT processor 511 FFT-processes the parallel data from the S/P converter 509 to output frequency-domain data.

The subcarrier demapper 513 extracts subcarrier values loaded with actual data from the output signal (i.e., subcarrier values) of the FFT processor 511. According to the present invention, the actual data of each FA is extracted using control information that is mapped to a predetermined section where the two FAs are adjacent to each other.

The demodulator 515 demodulates the actual data from the subcarrier demapper 513 by a predetermined demodulation scheme. The decoder performs a channel-decoding operation on the decoded data from the demodulator 515 at a predetermined coding rate, thereby restoring information data.

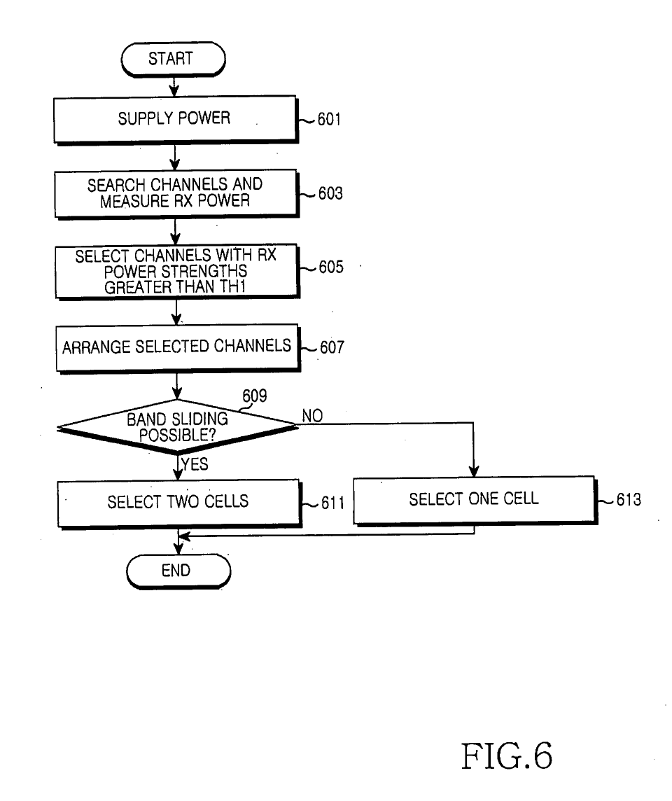

FIG. 6 is a flowchart illustrating a procedure for selecting cells at an MS according to the present invention. The following description is made with the assumption that channels are arranged in the descending order of strengths of the RX powers.

Referring to FIG. 6, the MS is supplied with power in step 601. In step 603, the MS searches channels in the order prestored in a table and measures the strength of the RX powers of the searched channels.

In step 605, the MS selects a predetermined number of the channels whose RX powers are greater than a predetermined level. That is, the MS compares the RX powers of the channels with a first threshold TH1 to select only the channels whose RX powers are greater than the first threshold TH1.

In step 607, the MS arranges the selected channels in the descending order of the RX powers. In step 609, the MS selects a channel with the highest RX power level and a channel with the second highest RX power and determines if the band sliding of the two selected channels is possible. If so, the MS proceeds step 611; and if not, the MS proceeds to step 613. The MS determines that the band sliding of the two channels is possible, when the FAs of the two channels are adjacent to each other and the two channels have similar RX power. Whether the two channels have similar RX power is determined considering a RX power difference of the two channels. This will be described in detail with reference to FIG. 7.

In step 611, the MS selects two cells that use the two adjacent channels. In step 613, the MS selects a cell that has the strongest RX power. Thereafter, the MS ends the procedure.

FIG. 7 is a flowchart illustrating a procedure for simultaneously selecting two BSs according to the present invention.

Referring to FIG. 7, the MS searches channels in the order prestored in a table and measures the strength of the RX powers of the searched channels in step 701 (see step 603 of FIG. 6). Thereafter, the MS selects only the channels whose RX powers are greater than the first threshold TH1, and arranges the selected channels in the descending order of the RX powers (e.g., see, steps 605 and 607 of FIG. 6).

In step 703, in order to perform band sliding, the MS groups cells of the channels in pairs to create cell sets, and arranges the cells of the cell sets in the descending order of the RX powers.

In step 705, the MS calculates a carrier frequency difference (|Pᵢ−Pⱼ|) and a RX power difference (|fᵢ−fⱼ|) of the two cells of the Kth cell set. “K” has an initial value of 1.

In step 707, the MS determines if the carrier frequencies of the two cells of the Kth cell set are adjacent to each other and the two cells have similar RX power. That is, the MS determines if the calculated RX power difference is smaller than a second threshold TH2 and the calculated carrier frequency difference is smaller than a third threshold TH3 (|Pᵢ−Pⱼ|<TH2 & |fᵢ−fⱼ<TH3). If so (|Pᵢ−Pⱼ|<TH2 & |fᵢ−fⱼ|<TH3), the MS proceeds to step 709; and if not, the MS proceeds to step 711.

In step 709, the MS performs band sliding for simultaneously receiving data signals from the two cells. Thereafter, the MS ends the procedure.

In step 711, the MS increases “K” by 1 (K=K+1). In step 713, the MS compares the increased K with the number T of the created cell sets (K<T?). If K≧T, the MS proceeds to step 715; and if K<T, the MS returns to step 705.

In step 715, the MS selects the cell that has the strongest RX power. Thereafter, the MS ends the procedure.

The above procedure can also be applied to reselection of cells.

As described above, the apparatus and method according to the present invention simultaneously receives data signals from two cells with adjacent FAs in a cellular environment with a frequency reuse factor of N, by sharing the adjacent FAs. Accordingly, it is possible to obtain a diversity effect.

While the present invention has been shown and described with reference to certain preferred embodiments thereof, it will be understood by those skilled in the art that various changes in form and details may be made therein without departing from the spirit and scope of the present invention as defined by the appended claims.

What is claimed is:

1. A mobile station apparatus for simultaneously receiving two adjacent frequency allocations (FAs) in a cellular communication system, the mobile station apparatus comprising:
a cell selector for detecting receive (RX) power strengths and FAs of adjacent cells to select a cell for performing communication;
a frequency controller for selecting, if the cell selector selects two cells with adjacent FAs, a carrier for simultaneously receiving the adjacent FAs of the two cells;
a local oscillator for generating the selected carrier; and
a multiplier for multiplying the generated carrier by a received signal to generate a baseband signal.

2. The mobile station apparatus of claim 1, wherein the cell selector:
measures the RX power strengths of the adjacent cells to select cells with RX power strengths greater than a first threshold; and selects two cells among the selected cells, if two cells have adjacent FAs and an RX power difference of the two cells is smaller than a second threshold.

3. The mobile station apparatus of claim 2, wherein the cell selector:
arranges selected channels in the descending order of the RX powers; and
selects cells having first and second highest RX power.

4. The mobile station apparatus of claim 2, wherein the cell selector determines that two cells use adjacent FAs, if a carrier frequency difference between the two cells is smaller than a third threshold.

5. The mobile station apparatus of claim 2, wherein a cell selector selects the cell with the strongest RX power, if two cells among the selected cells have adjacent FAs and an RX power difference of the two cells is greater than or equal to a second threshold.

6. The mobile station apparatus of claim 1, wherein the frequency controller selects the carrier such that the carrier includes a preamble of the minimum bandwidth for discriminating between base stations (BSs) and channel allocation information of each of the two adjacent FAs.

7. The mobile station apparatus of claim 6, wherein the frequency controller maps the channel allocation information to a subcarrier of a predetermined section where the FAs are adjacent to each other.

8. The mobile station apparatus of claim 6, wherein the frequency controller repeatedly maps the preamble throughout an FA of the corresponding BS.

9. The mobile station apparatus of claim 1, further comprising:
an analog-to-digital (A/D) converter for converting the baseband signal from the multiplier into a digital signal;
a fast Fourier transform (FFT) processor for FFT-processing the digital signal from the A/D converter; and
a subcarrier demapper for receiving an output signal from the FFT processor and extracting actual data from the output signal from the FFT processor by using control information mapped to a subcarrier of a predetermined section where the two FAs are adjacent to each other.

10. A method for simultaneously selecting two cells in a cellular communication system, the method comprising the steps of:
searching adjacent cells and measuring receive (RX) power strengths of the adjacent cells;
selecting cells with RX power strengths greater than a predetermined value among the adjacent cells;
selecting two cells among the selected cells and comparing the frequency allocations (FAs) and RX power strengths of the two cells; and
selecting the two cells to perform communication, if the two cells have adjacent FAs and similar RX power strengths.

11. The method of claim 10, further comprising:
arranging selected channels in the descending order of the RX powers; and
selecting cells with the first and second strongest RX power among the selected channels.

12. The method of claim 10, wherein the step of comparing the FAs and RX power strengths of the two cells selected to perform the communication comprises:
comparing a carrier frequency difference of the two cells selected to perform the communication with a first threshold; and
comparing an RX power difference of the two cells selected to perform the communication with a second threshold, if the carrier frequency difference is smaller than the first threshold.

13. The method of claim 12, wherein:
the two cells selected to perform the communication are determined to be adjacent cells if the carrier frequency difference is smaller than the first threshold; and
the RX power strengths are determined to be similar to each other if the RX power difference is smaller than the second threshold.

14. The method of claim 10, further comprising the step of selecting the cell with the strongest RX power if there is no cells having adjacent FAs and similar RX powers are not found.

15. A mobile station apparatus for simultaneously receiving adjacent frequency allocations (FAs) in a cellular communication system, the mobile station apparatus comprising:
a cell selector for detecting receive (RX) power strengths and FAs of adjacent cells to select a cell for performing communication;
a frequency controller for selecting, if the cell selector selects cells with adjacent FAs, a carrier for simultaneously receiving the adjacent FAs of the cells; and
a local oscillator for generating the selected carrier.

16. The mobile station apparatus of claim 15, further comprising a multiplier for multiplying the generated carrier by a received signal to generate a baseband signal.

17. The mobile station apparatus of claim 15, wherein the cell selector:
measures the RX power strengths of the adjacent cells to select cells with RX power strengths greater than a first threshold; and selects cells among the selected cells, if cells have adjacent FAs and an RX power difference of the two cells is smaller than a second threshold.

18. The mobile station apparatus of claim 17, wherein the cell selector:
arranges selected channels in the descending order of the RX powers; and
selects cells having first and second highest RX power.

19. The mobile station apparatus of claim 17, wherein the cell selector determines that two cells use adjacent FAs, if a carrier frequency difference between the two cells is smaller than a third threshold.

20. A method for simultaneously selecting cells in a cellular communication system, the method comprising the steps of:
searching adjacent cells and measuring receive (RX) power strengths of the adjacent cells;
selecting cells with RX power strengths greater than a predetermined value among the adjacent cells;
selecting cells among the selected cells and comparing the frequency allocations (FAs) and RX power strengths of the cells; and
selecting the cells to perform communication, if the cells have adjacent FAs and a difference of the RX power strengths is smaller than the predetermined threshold.
